(19) United States
(12) Patent Application Publication
(10) Pub. No.: US 2013/0137380 A1
(43) Pub. Date: May 30, 2013

(54) METHOD AND SYSTEM FOR TESTING A WIRELESS NETWORK DEVICE

(71) Applicants: Yu-Chen Lu, New Taipei City (TW); Yung-Hung Lan, Taipei City (TW); Ching-Feng Hsieh, Taipei (TW)

(72) Inventors: Yu-Chen Lu, New Taipei City (TW); Yung-Hung Lan, Taipei City (TW); Ching-Feng Hsieh, Taipei (TW)

(73) Assignees: ASKEY COMPUTER CORPORATION; ASKEY TECHNOLOGY (JIANGSU) LTD., Wujiang Economic-Technological (CN)

(21) Appl. No.: 13/434,444

(22) Filed: Mar. 29, 2012

(30) Foreign Application Priority Data
Nov. 25, 2011 (TW) 100143279

(51) Int. Cl. H04B 17/00

(52) U.S. Cl. 455/67.14

(57) ABSTRACT

A method for testing a wireless network device includes: setting a preset number of test packet samples to be received by a test apparatus, setting wireless radio frequency (RF) parameters of the wireless network device, and setting wireless RF test parameters of the test apparatus; sending, by using the wireless network device, test packets according to the wireless RF parameters, and capturing, by using the test apparatus, the test packets according to the wireless RF test parameters, so as to generate test data until a number of the captured test packets reaches the preset number of test packet samples; and operating the test data to generate a test result, thereby increasing the test efficiency of the wireless network device and improving the utilization rate of the test apparatus.

### BACKGROUND OF THE INVENTION

1. Field of the Invention

The present invention relates to test techniques for wireless network devices, and, more particularly, to a method for testing a wireless network device integrating test apparatuses and a system for testing the wireless network device.

2. Description of Related Art

Accessing a wireless local area network (WLAN) refers to connection with a WLAN through a wireless network card and a wireless access point (AP). The access point can be further connected to an external access line such as an asymmetric digital subscriber line (ADSL), an optical fiber and so on, so as to maximize the use of wireless network resources. Today, WLANs have become quite popular due to their high transmission speeds and low construction costs.

Currently, in order to ensure that wireless network devices manufactured by various manufacturers are compatible and stable, the wireless network devices are required to meet wireless network standards. Therefore, manufacturers set up a series of test procedures to ensure that their products meet the standards.

Generally, according to radio frequency (RF) specifications, various RF test instruments such as spectrum analyzers, vector signal analyzers, vector signal generators, RF power meters and power splitters are used to set up various test environments. Parameters of the test instruments and wireless network devices under test are manually set by operators so as to manually perform RF measurements and record data. Then, the data is analyzed to generate a test report a. Such a test process is time-consuming and susceptible to errors.

Therefore, there is a need to provide test techniques for a wireless network device so as to overcome the above-described drawbacks.

### SUMMARY OF THE INVENTION

In view of the above-described drawbacks, an object of the present invention is to provide a method for testing a wireless network device and a system thereof, so as to save manual power and improve the test apparatus utilization rate.

Another object of the present invention is to provide a method for testing a wireless network device and a system thereof, so as to increase the measurement range and data accuracy and avoid unnecessary errors.

A further object of the present invention is to provide a method for testing a wireless network device and a system thereof, so as to integrate test apparatuses and simplify the test process.

To achieve the above and other objects, the present invention provides a method for testing a wireless network device, comprising: setting a preset number of test packet samples to be received by a test apparatus, setting wireless RF parameters of the wireless network device, and setting wireless RF test parameters of the test apparatus; sending, by using the wireless network device, test packets according to the wireless RF parameters, and capturing, by using the test apparatus, the test packets according to the wireless RF test parameters, so as to generate test data until a number of the captured test packets reaches the preset number of test packet samples; and operating the test data to generate a test result.

In an embodiment of the present invention, the wireless RF parameters of the wireless network device comprise at least one selected from the group consisting of packet size, packet sending frequency and rate, the wireless RF test parameters of the test apparatus refer to vector signal analysis parameters of the test apparatus, and the vector signal analysis parameters of the test apparatus correspond to the packet sending frequency and rate of the wireless network device.

The method further comprises setting a number of the test apparatuses corresponding to a number of antennas of the wireless network device.

The present invention further provides a system for testing a wireless network device, comprising: a setting module for setting test parameters, the setting module comprising wireless RF parameters of a wireless network device, a preset number of test packet samples to be received by a test apparatus, and wireless RF test parameters of the test apparatuses; a test module for enabling the wireless network device to send test packets according to the wireless RF parameters and enabling the test apparatus to receive the test packets according to the wireless RF test parameters, so as to generate test data; and an analysis module for determining whether a number of the test packets captured by the test apparatus coincides with the preset number of test packet samples and operating the test data when the number of the captured test packets coincides with the preset number of test packet samples to thereby generate a test result.

In an embodiment of the present invention, the wireless RF parameters of the wireless network device comprise at least one selected from the group consisting of packet size, packet sending frequency and rate, the wireless RF test parameters of the test apparatus refer to vector signal analysis parameters of the test apparatus, and the vector signal analysis parameters of the test apparatus correspond to the packet sending frequency and rate of the wireless network device.

Therefore, by integrating the design and development of test apparatuses, the present invention eliminates the need of manual operations so as to save manual power and time, increase the test efficiency of the wireless network device and improve the utilization rate of the test apparatuses, thereby increasing data accuracy, avoiding unnecessary errors and simplifying the test process.

### BRIEF DESCRIPTION OF DRAWINGS

FIG. 1 is a block diagram showing a system for testing a wireless network device according to the present invention;

FIG. 2 is a flow diagram showing a method for testing a wireless network device according to the present invention; and

FIG. 3 is a flow diagram showing an example of the method according to the present invention.

### DETAILED DESCRIPTION OF PREFERRED EMBODIMENTS

The following illustrative embodiments are provided to illustrate the disclosure of the present invention, these and other advantages and effects can be apparent to those in the art after reading this specification.

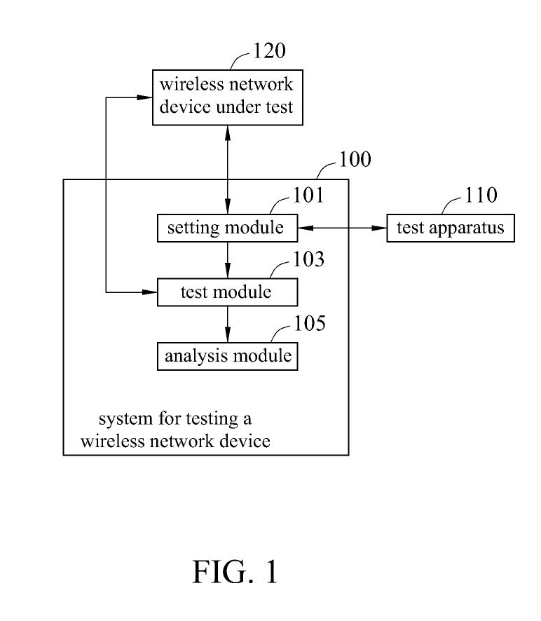

FIG. 1 shows a system 100 for testing a wireless network device 120 according to the present invention.

Referring to FIG. 1, the test system 100 has a setting module 101, a test module 103, and an analysis module 105. In an embodiment, the system 100 is applicable to a wireless network device compatible with wireless network standards, such as an AP device.

The setting module 101 allows users to set test parameters. In an embodiment, the test system 100 provides a graphic setting interface for the users to set related test parameters. The test parameters include wireless RF parameters of the wireless network device 120, a preset number of test packet samples to be received by a test apparatus 110, and wireless RF test parameters of the test apparatus 110. The setting module 101 further allows the user to set wireless network standards to be tested, such as IEEE 802.11 a/b/g/n or user-defined standards. In particular, the wireless RF parameters of the wireless network device 120 include packet size, packet sending frequency and rate. The wireless RF test parameters of the test apparatus 110 refer to vector signal analysis parameters of the test apparatus 110. The vector signal analysis parameters of the test apparatus 110 correspond to the packet sending frequency and rate of the wireless network device 120.

The test module 103 is used for enabling the wireless network device 120 to send test packets according to the wireless RF parameters and enabling the test apparatus 110 to capture the test packets according to the wireless RF test parameters so as to generate test data.

The analysis module 105 is used to determine whether a number of the test packets captured by the test apparatus 110 coincides with the preset number of test packet samples preset by the setting module 101. If the number of the captured test packets coincides with the preset number of test packet samples, the analysis module 105 operates the test data to thereby generate a test result.

In an embodiment, the RMS value of the test data is obtained to determine whether the test result successes or fails. That is, if the number of the captured test packets coincides with the preset number of test packet samples, the test data is determined to be effective. Then, the RMS value of the test data is calculated to determine whether the test successes or fails. It should be noted that the present invention is not limited to the RMS operation. Instead, various operation methods can be used to determine whether the test result successes or fails.

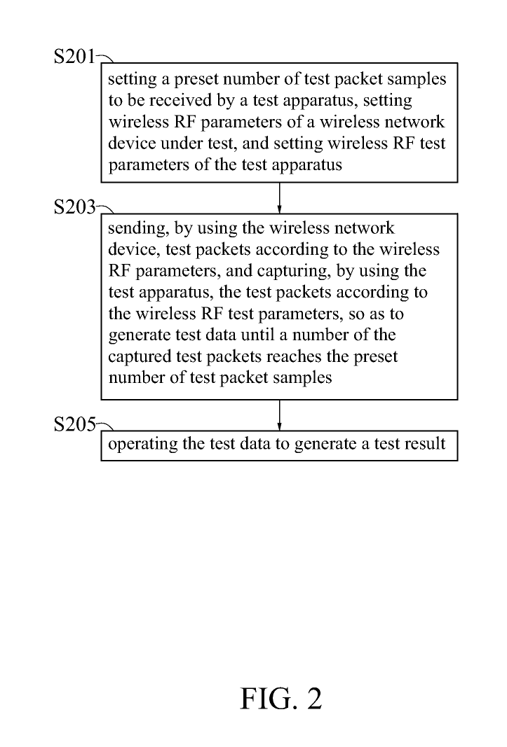

FIG. 2 is a flow diagram showing a method for testing a wireless network device according to the present invention.

At step S201, the preset number of test packet samples to be received by a test apparatus, the wireless RF parameters of a wireless network device under test, and the wireless RF test parameters of the test apparatus are set. That is, in step S201 internal parameters of the test apparatus and the wireless network device under test are set, so as to enable the test apparatus and the wireless network device to communicate with each other when sending and receiving packets. Further, the number of test packet samples is set and compared with the preset number of test packets actually received by the test apparatus. Then, the method goes to step S203.

At step S203, the wireless network device under test sends test packets according to the wireless RF parameters, and the test apparatus captures the test packets according to the preset wireless RF test parameters, so as to generate test data until the number of the captured test packets reaches the preset number of test packet samples.

If the number of the test packets captured by the test apparatus does not coincide with the preset number of test packet samples, the parameters of the test apparatus and the wireless network device can be adjusted so as to ensure the number of received test packets can reach the preset number. Then, the method goes to step S205.

At step S205, the test data is operated to generate a test result. If the number of the test packets received by the test apparatus is correct, the test data is determined to be effective. Then the effective test data is operated to generate the test result.

In an embodiment, the RMS of the test data is obtained and compared with a preset value, to thereby determine whether the test successes or fails.

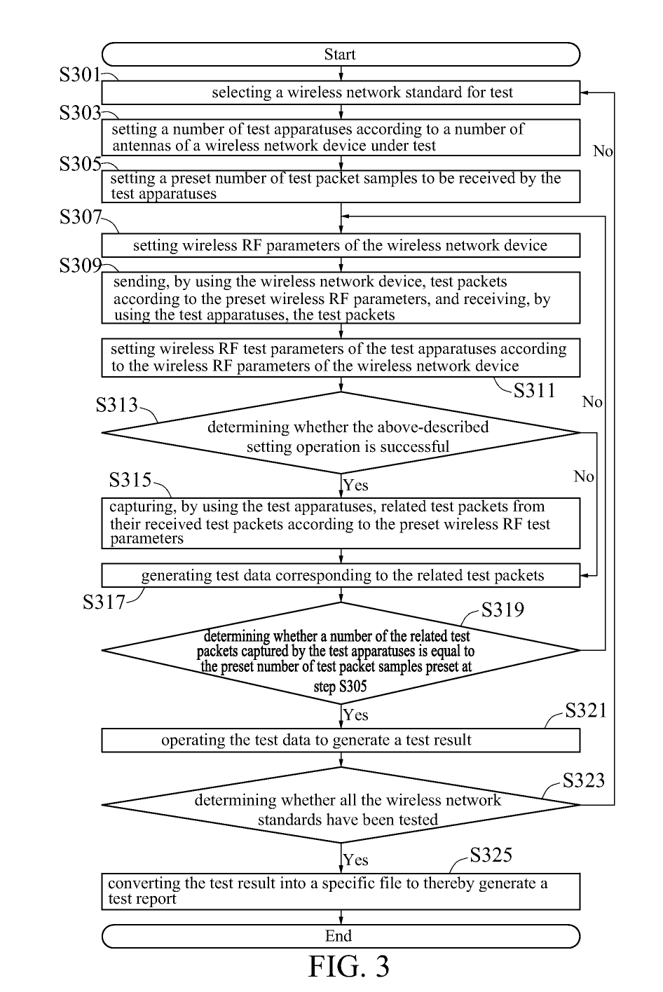

FIG. 3 shows a method for testing a wireless network device according to an embodiment of the present invention.

Referring to FIG. 3 in combination with FIG. 1, at step S301 a wireless network standard to be tested is selected. In an embodiment, four wireless network standards such as IEEE 802.11 a/b/g/n are provided. Then, the method goes to step S303. Alternatively, user-defined standards can be provided.

At step S303, according to the number of antennas of the wireless network device 120 a corresponding number of test apparatuses 110 are provided. For example, if the wireless network device 120 is an AP with two antennas, two test apparatuses 110 can be provided. The test apparatuses 110 can integrate vector signal analyzers, vector signal generators or RF power meters. Then, the method goes to step S305.

At step S305, the number of test packet samples to be received by the test apparatuses 110 is defined. For example, the test apparatuses 110 are set to receive ten test packets. Then, the method goes to step S307.

At step S307, wireless RF parameters of the wireless network device 120 are set. The wireless RF parameters include packet size, packet sending frequency and rate. Then, the method goes to step S309.

At step S309, the wireless network device 120 sends test packets according to the preset wireless RF parameters, and the test apparatuses 110 receive the test packets. Then, the method goes to step S311.

At step S311, wireless RF test parameters of the test apparatuses 110 are set according to the wireless RF parameters of the wireless network device 120. In an embodiment, the wireless RF test parameters of the test apparatuses 110 refer to vector signal analysis parameters of the test apparatuses, and the vector signal analysis parameters of the test apparatuses correspond to the packet sending frequency and rate of the wireless network device 120. Then, the method goes to step S313.

At step S313, whether the above-described setting operation successes is determined; if yes, the method goes to step S315; otherwise, the method goes to step S317 to record related data in a record file.

At step S315, the test apparatuses 110 capture related test packets from their received test packets according to the preset wireless RF test parameters. The setting module allows the user to set parameter rules of various wireless network standards or user-defined parameter rules. Then, the method goes to step S317.

At step S317, test data are generated according to the captured related test packets. Further, at step S317 both fail records from step S313 and test records from step S317 are recorded in a record file to serve as a base for subsequent adjustment. Then, the method goes to step S319.

At step S319, whether the number of the related test packets captured by the test apparatuses 110 is equal to the preset number of test packet samples preset at step S305 is determined, i.e. whether the number of the related test packets captured by the test apparatus 110 is ten is determined; if yes, the method goes to step S321; otherwise, the method goes to step S307 for parameter adjustment.

At step S321, the generated test data is operated to generate a test result. In an embodiment, the RMS of the ten test data is obtained to thereby determine whether the test result successes or fails. Then, the method goes to step S323.

At step S323, whether all the wireless network standards have been tested is determined; if yes, the method goes to step S325; otherwise, the method goes back to step S301 for testing another wireless network standard. Similarly, whether the user-defined standards have been tested can be determined

At step S325, the test result is converted into a specific file such as an excel file so as to generate a test report for users to read.

Therefore, the method and system according to the present invention integrate test apparatuses so as to effectively shorten the test time, simplify the test process, improve the test efficiency of the wireless network device, increase the utilization rate of the test apparatuses, and avoid unnecessary errors. Further, since the test result is generated based on operation of several test data, the data accuracy is improved.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims.

What is claimed is:

1. A method for testing a wireless network device, comprising:
setting a preset number of test packet samples to be received by a test apparatus, setting wireless radio frequency (RF) parameters of the wireless network device, and setting wireless RF test parameters of the test apparatus;
sending, by using the wireless network device, test packets according to the wireless RF parameters, and capturing, by using the test apparatus, the test packets according to the wireless RF test parameters, so as to generate test data until a number of the captured test packets reaches the preset number of test packet samples; and
operating the test data to generate a test result.

2. The method of claim 1, wherein the wireless RF parameters of the wireless network device comprise at least one selected from the group consisting of packet size, packet sending frequency and rate.

3. The method of claim 2, wherein the wireless RF test parameters of the test apparatus refer to vector signal analysis parameters of the test apparatus.

4. The method of claim 3, wherein the vector signal analysis parameters of the test apparatus correspond to the packet sending frequency and rate of the wireless network device.

5. The method of claim 1, further comprising setting a number of the test apparatus corresponding to a number of antennas of the wireless network device.

6. A system for testing a wireless network device, comprising:
a setting module for setting test parameters, the setting module comprising wireless RF parameters of a wireless network device, a preset number of test packet samples to be received by a test apparatus, and wireless RF test parameters of the test apparatus;
a test module for enabling the wireless network device to send test packets according to the wireless RF parameters and enabling the test apparatus to receive the test packets according to the wireless RF test parameters so as to generate test data; and
an analysis module for determining whether a number of the test packets captured by the test apparatus coincides with the preset number of test packet samples, and operating the test data when the number of the captured test packets coincides with the preset number of test packet samples to thereby generate a test result.

7. The system of claim 6, wherein the wireless RF parameters of the wireless network device comprise at least one selected from the group consisting of packet size, packet sending frequency and rate.

8. The system of claim 7, wherein the wireless RF test parameters of the test apparatus refer to vector signal analysis parameters of the test apparatus.

9. The system of claim 8, wherein the vector signal analysis parameters of the test apparatus correspond to the packet sending frequency and rate of the wireless network device.

10. The system of claim 6, wherein the setting module sets parameter rules of various wireless network standards or user-defined parameter rules.
